(19) United States
(12) Patent Application Publication
(10) Pub. No.: US 2012/0313031 A1
(43) Pub. Date: Dec. 13, 2012

(54) COMPOUNDS MADE OF (CYCLO)ALIPHATIC DIISOCYANATES AND AROMATIC ACID HALIDES

(75) Inventors: Dirk Hoppe, Nottuln (DE); Christoph Nacke, Schermbeck (DE); Rainer Lomoelder, Muenster (DE)

(73) Assignee: EVONIK DEGUSSA GmbH, Essen (DE)

(21) Appl. No.: 13/516,457

(22) PCT Filed: Oct. 12, 2010
(86) PCT No.: PCT/EP2010/065237

§ 371 Date: Jul. 27, 2012

(30) Foreign Application Priority Data
Dec. 16, 2009 (DE) 102009054749.5

(51) Int. Cl. C08G 18/34; C09D 11/00; E04B 1/74; C09K 3/00

(52) U.S. Cl. 252/62; 252/182.2; 106/287.23; 106/31.13; 528/59

(57) ABSTRACT

The invention relates to compounds made of (cyclo)aliphatic diisocyanates, produced according to a multi-stage method (phosgene-free production), which comprises the conversion of (cyclo)aliphatic diamines into the corresponding (cyclo)alkylene biscarbamates and the thermal cleavage of the latter into the (cyclo)alkylene diisocyanates and alcohol (urea route), and aromatic acid halides, and to the use thereof.

The invention relates to compositions of (cyclo)aliphatic diisocyanates, produced by a multistage process (phosgene-free production), which comprises the conversion of (cyclo)aliphatic diamines to the corresponding (cyclo)alkylene biscarbamates and the thermal cleavage of the latter to the (cyclo)alkylene diisocyanates and alcohol—the urea route—and aromatic acid chlorides (halides), and to the use thereof.

Diisocyanates are valuable chemical compounds which, by the principle of the diisocyanate polyaddition process, allow the controlled formation of polymers which find various industrial uses as polycarbamates or polyureas in foams, elastomers, thermoplastics, fibers, light-stable polycarbamate coatings or adhesives.

Isocyanates can be obtained synthetically via a number of different routes. The oldest variant, which is still prevalent today, for industrial scale preparation of isocyanates is the phosgenation of the corresponding amines using corrosive, very toxic phosgene containing a high proportion of chlorine, the handling of which on the industrial scale is particularly demanding. Apart from the target products, this process gives rise to a number of unwanted chlorinated by-products.

There are several methods of avoiding the use of phosgene for preparation of isocyanates on the industrial scale. The term “phosgene-free process” is frequently utilized in connection with the conversion of amines to isocyanates using alternative carbonylating agents, for example, urea or dialkyl carbonate, (EP 18 586, EP 355 443, U.S. Pat. No. 4,268,683, EP 990 644).

The basis of what is called the urea route is the urea-mediated conversion of diamines to diisocyanates via a two-stage process. In the first process step, a diamine is reacted with alcohol in the presence of urea or urea equivalents (e.g. alkyl carbonates, alkyl carbamates) to give a biscarbamate, which typically passes through an intermediate purification stage and is then cleaved thermally in the second process step to diisocyanate and alcohol (EP 126 299, EP 126 300, EP 355 443, U.S. Pat. No. 4,713,476, U.S. Pat. No. 5,386,053). Alternatively, the actual biscarbamate formation may also be preceded by the separate preparation of a bisurea by controlled reaction of the diamine with urea (EP 568 782). Also conceivable is a two-stage sequence composed of partial reaction of urea with alcohol in the first step and subsequent metered addition and carbamatization of the diamine in the second step (EP 657 420).

The thermal cleavage of (cyclo)aliphatic biscarbamates can be effected in the gas or liquid phase, with or without solvent and with or without catalysts. For instance, EP 126 299 and EP 126 300 describe processes for preparing hexamethylene diisocyanate or isophorone diisocyanate by cleaving the corresponding biscarbamates in the gas phase in a tubular reactor in the presence of metallic random packings at 410° C.

The preparation of (cyclo)aliphatic biscarbamates in a one-pot reaction from diamine, urea and alcohol with simultaneous removal of ammonia is known from EP 18 568. The teaching of EP 18 568 has been developed and is described in EP 126 299, EP 126 300, EP 355 443, EP 566 925 and EP 568 782. Newer processes for preparing (cyclo)aliphatic diisocyanates are known from EP1512681, EP1512682, EP1512680, EP1593669, EP1602643, EP1634868, EP 2091911.

The reaction via the urea route leads to the formation of unwanted by-products, for example tertiary amines, in one-stage processes, two-stage processes and also in alternative multistage processes for preparation of (cyclo)aliphatic biscarbamates, and also in the subsequent thermal cleavage of the (cyclo)aliphatic biscarbamates to (cyclo)aliphatic diisocyanates. It has been found that the by-products from the urea route have an accelerating influence on the reaction rate in the reaction of (cyclo)aliphatic diisocyanates with compounds containing OH groups for preparation of light-stable polyurethanes, one of the main applications of this substance class. This different reactivity impairs the interchangeability of the (cyclo)aliphatic diisocyanates prepared by the phosgene process with those prepared by the urea route.

It is an object of the invention to provide novel compositions which avoid the above-mentioned disadvantages.

The object is achieved, surprisingly, by reducing the reactivity of (cyclo)aliphatic diisocyanates, prepared by a process according to the urea route, by adding aromatic acid halides, especially aromatic acid chlorides.

The invention provides a composition essentially comprising
A) at least one (cyclo)aliphatic diisocyanate prepared by reaction of at least one (cyclo)aliphatic diamine with urea and/or urea equivalents and at least one alcohol to give (cyclo)aliphatic biscarbamates and subsequent thermal cleavage of the (cyclo)aliphatic biscarbamates to give (cyclo)aliphatic diisocyanates,
   and
B) at least one aromatic acid halide.

It has been found that, surprisingly, the reactivity of the (cyclo)aliphatic diisocyanate prepared by the urea route, for example methylene dicyclohexyl diisocyanate (H₁₂MDI), isophorone diisocyanate (IPDI), 2,2,4- and 2,4,4-trimethylhexamethylene diisocyanate (TMDI) and hexamethylene diisocyanate (HDI), especially in the case of methylene dicyclohexyl diisocyanate (H₁₂MDI), can be lowered by adding a suitable amount of an aromatic acid halide to the level of the corresponding diisocyanate prepared by the phosgene process, especially in the case of H₁₂MDI.

For example, the conversion in the case of non-catalyzed reaction of an H₁₂MDI prepared by the urea route with n-octanol at 80° C., determined as the percentage decrease in the NCO groups in the reaction mixture in percent by weight, is 72% after five hours, whereas the conversion in the case of the reaction of the corresponding H₁₂MDI prepared by the phosgene process is only 38%.

Thus, the reactivity of the H₁₂MDI prepared by the urea route is almost 100% greater than that of the corresponding H₁₂MDI prepared by the phosgene process.

The addition of 0.02% of an inventive aromatic acid halide, especially benzyl chloride, reduces the reactivity by about 50% and, in the same experiment mentioned above (reaction of an H₁₂MDI prepared by the urea route with n-octanol at 80° C.) is 38% after 5 hours.

According to the invention, an aromatic acid halide is used as component B). Chlorides, fluorides, bromides and iodides are suitable. Preference is given to acid chlorides. Suitable compounds are benzoyl chloride, phthaloyl dichloride, isophthaloyl dichloride, terephthaloyl dichloride, o-tolyl dichloride, m-tolyl dichloride and p-tolyl dichloride. Particular preference is given to using benzyl chloride.

The amount of component B) in the inventive composition varies from 0.0001 to 1.0% by weight based on the (cyclo)aliphatic diisocyanate A) prepared by the urea process used. Preference is given to using 0.001-0.9% by weight and particular preference to using 0.002-0.5% by weight.

Processes for continuously preparing (cyclo)aliphatic diisocyanates by reaction of at least one (cyclo)aliphatic diamine with urea and/or urea equivalents and at least one alcohol to give (cyclo)aliphatic biscarbamates and subsequent thermal cleavage of the (cyclo)aliphatic biscarbamates to give (cyclo)aliphatic diisocyanates, are described, for example, in EP 18 568, EP 126 299, EP 126 300, EP 355 443, EP 566 925.

For the preparation of (cyclo)aliphatic diisocyanates, especially for H₁₂MDI, preference is given to using processes according to EP 1 512 681, EP 1 512 682, EP 1 512 680, EP 1 593 669, EP 1 602 643, EP 1 634 868 and EP 2 091 911, and also EP 355 443, EP 568 782 and EP 2 091 911 for isophorone diisocyanate (IPDI).

The diisocyanates are more preferably prepared by the following process according to the urea route:
a process for continuously preparing (cyclo)aliphatic diisocyanates of the formula (I)

OCN—R—NCO

where R is a straight-chain or branched aliphatic hydrocarbyl radical having a total of 6 to 12 carbon atoms or an optionally substituted cycloaliphatic hydrocarbyl radical having a total of 4 to 18 and preferably 5 to 15 carbon atoms, by reacting (cyclo)aliphatic diamines with unconditioned urea and/or urea equivalents prepared from unconditioned urea and alcohols to give (cyclo)aliphatic biscarbamates and the thermal cleavage thereof, which is characterized by the following individual steps:
a) (cyclo)aliphatic diamines of the formula (II)

H₂N—R—NH₂
where R is a straight-chain or branched aliphatic hydrocarbyl radical having a total of 6 to 12 carbon atoms or an optionally substituted cycloaliphatic hydrocarbyl radical having a total of 4 to 18 and preferably 5 to 15 carbon atoms are reacted with unconditioned urea and/or urea equivalents prepared from unconditioned urea in the presence of alcohol of the formula (III)

R¹—OH
where R¹ is a radical as remains after removal of the hydroxyl group from a primary or secondary (cyclo)aliphatic alcohol having 3 to 8 carbon atoms, in the absence or presence of dialkyl carbonates, alkyl carbamates or mixtures of dialkyl carbonates and carbamic esters, and in the absence or presence of catalysts, to give (cyclo)alkylenebisurea of the formula (IV)

H₂N—OC—HN—R—NH—CO—NH₂
where R is a straight-chain or branched aliphatic hydrocarbyl radical having a total of 6 to 12 carbon atoms or an optionally substituted cycloaliphatic hydrocarbyl radical having a total of 4 to 18 and preferably 5 to 15 carbon atoms, in a distillation reactor, with simultaneous removal of the ammonia formed, the reactants being introduced continuously to the uppermost tray and the ammonia formed being driven out by distillation with alcohol vapors which are introduced in the bottom;
b) in the second stage, the reaction of the (cyclo)alkylenebisurea obtained from the first stage a) with the alcohol used as solvent in a) is performed in a pressure distillation reactor with simultaneous removal of the ammonia formed to give the (cyclo)alkylene biscarbamate of the formula (V)

R¹O—OC—HN—R—NH—CO—OR¹;
c) or optionally the reaction of (cyclo)aliphatic diamines of the formula (II)

H₂N—R—NH₂
with unconditioned urea and/or urea equivalents prepared from unconditioned urea, in the presence of alcohol of the formula (III)

R¹—OH
is performed in a pressure distillation reactor in one stage with simultaneous removal of the ammonia formed to give the (cyclo)alkylene biscarbamate of the formula (V)

R¹O—OC—HN—R—NH—CO—OR¹
without steps a) and b) (R and R¹ correspond to the above definition);
d) the alcohol, the dialkyl carbonates and/or alkyl carbamates are removed from the reaction mixture obtained from b) or optionally c), and the alcohol and optionally also the dialkyl carbonates and/or alkyl carbamates are recycled into reaction stage a) or b) or optionally c);
e) the removal of ammonia from the vapors obtained at the top of the pressure distillation reactor either from b) or optionally from c), and from the alcohol which is obtained by partial condensation of the vapors from the distillation reactor a) or optionally c), is performed in a downstream column, appropriately under the pressure of the pressure distillation reactor, the ammonia-free alcohol obtained in the bottom being recycled into the bottom of the distillation reactor and/or into the bottom of the pressure distillation reactor;
f) the crude (cyclo)alkylene biscarbamate depleted of low boilers from d) is removed completely or partially from high-boiling residues, or a residue removal is optionally omitted;
g) the reaction mixture which contains (cyclo)alkylene biscarbamates and has been pretreated by means of steps d) and optionally f) is cleaved thermally in the presence of a catalyst, continuously and without solvent, at temperatures of 180 to 280° C., preferably 200 to 260° C., and under a pressure of 0.1 to 200 mbar, preferably 0.2 to 100 mbar, in such a way that a portion of the reaction mixture of 10 to 60% by weight based on the feed, preferably 15 to 45% by weight based on the feed, is discharged continuously from the bottom;
h) the cleavage products from step g) are separated by rectification into a (cyclo)aliphatic crude diisocyanate and alcohol;
i) the (cyclo)aliphatic crude diisocyanate is purified by distillation and the fraction containing (cyclo)aliphatic pure diisocyanate is isolated;
j) the bottoms discharge from g) is reacted partially or completely with the alcohol from h) in the presence or absence of catalysts within 1 to 150 min, preferably 3 to 60 min, at temperatures of 20 to 200° C., preferably 50 to 170° C., and at a pressure of 0.5 to 20 bar, preferably 1 to 15 bar, where the molar ratio of NCO groups and OH groups is up to 1:100, preferably 1:20 and more preferably 1:10;
k) the reaction mixture from j) is separated into a material of value stream and a waste stream, and the waste stream which is rich in high boiler components is discharged from the process and discarded;
l) optionally the reaction mixture from j) is recycled directly into the (cyclo)alkylene biscarbamate stage b) or optionally c);
m) a portion of the bottoms fraction of the purifying distillation i) is discharged continuously and conducted into the cleavage reaction g) and/or into the carbamatization stage j);
n) optionally the top fractions obtained in the purifying distillation of the (cyclo)aliphatic crude diisocyanate are likewise recycled into the carbamatization stage j);
o) the material of value stream from k) is recycled into stage b) or optionally c) and/or d) and/or g).

A further exact description of steps a) to o) can be found in WO 2008/077672-A, pages 17 to 26 (corresponds to EP 2 091 911 A).

Starting compounds for the process are diamines of the formula (II) already specified above, alcohols of the formula (III) already specified above, and urea and/or urea equivalents prepared from urea.

Suitable diamines of the formula (II) are aliphatic diamines, for example hexamethylenediamine, 2-methylpentamethylenediamine, octamethylenediamine, 2,2,4- and 2,4,4-trimethylhexamethylenediamine or mixtures thereof, decamethylenediamine, 2-methylnonamethylenediamine, dodecamethylenediamine, and cycloaliphatic diamines, for example 1,4-cyclohexanediamine, 1,3- or 1,4-cyclohexanedimethanamine, 5-amino-1,3,3-trimethylcyclohexanemethanamine (isophoronediamine), 4,4′-methylenedicyclohexyldiamine, 2,4-methylenedicyclohexyldiamine, 2,2′-methylenedicyclohexyldiamine and isomeric (cyclo)aliphatic diamines, and also perhydrogenated methylenediphenyldiamine (H₁₂MDA). As a result of the preparation, methylenediphenyldiamine (MDA) is obtained as an isomer mixture of 4,4′-, 2,4- and 2,2′-MDA (see, for example, DE 101 27 273). Perhydrogenated methylenediphenyldiamine is obtained by full hydrogenation from MDA and is accordingly a mixture of isomeric methylenedicyclohexyldiamines (H₁₂MDA), specifically 4,4′-, 2,4- and 2,2′-H₁₂MDA, and possibly small amounts of incompletely converted (partly) aromatic MDA. Preference is given to using, as diamines of the formula (II), 5-amino-1,3,3-trimethylcyclohexanemethanamine (isophoronediamine), 2,2,4- and 2,4,4-trimethyl-hexamethylenediamine or mixtures thereof, 4,4′-methylenedicyclohexyldiamine, 2,4-methylenedicyclohexyldiamine and 2,2′-methylenedicyclohexyldiamine, and also any desired mixtures of at least two of these isomers, and also hexamethylenediamine and 2-methyl-pentamethylenediamine.

Suitable alcohols of the formula (III) are any desired aliphatic or cycloaliphatic alcohols which have a boiling point below 190° C. under standard pressure. Examples include C1-C6-alkanols, for example methanol, ethanol, 1-propanol, 1-butanol, 2-butanol, 1-hexanol or cyclohexanol. Preference is given to using 1-butanol as the alcohol.

In principle, it is possible for all known (cyclo)aliphatic diisocyanates, which in the context of the invention means aliphatic diisocyanates and cycloaliphatic diisocyanates, the latter containing NCO groups bonded to the cycloaliphatic base structure directly and/or via alkyl groups, to be present as component A) in the inventive compositions.

Particularly suitable diisocyanates are aliphatic diisocyanates having a straight-chain or branched aliphatic hydrocarbyl radical having a total of 6 to 12 carbon atoms such as hexamethylene diisocyanate (HDI), 2-methylpentane diisocyanate, 2,2,4- and 2,4,4-trimethylhexamethylene diisocyanate or mixtures thereof, octamethylene diisocyanate, decamethylene diisocyanate, 2-methylnonamethylene diisocyanate or dodecamethylene diisocyanate. Likewise particularly suitable are cycloaliphatic diisocyanates having an optionally substituted cycloaliphatic hydrocarbyl radical having a total of 4 to 18, and preferably 5 to 15 carbon atoms, for example 1,4-diisocyanatocyclohexane, 1,3- or 1,4-cyclohexanedimethane isocyanate, 5-isocyanato-1,3,3-trimethylcyclohexanemethane isocyanate (isophorone diisocyanate) 4,4′-methylene dicyclohexyl diisocyanate (4,4′-H₁₂MDI), 2,2′-methylene dicyclohexyl diisocyanate (2,2′-H₁₂MDI), 2,4′-methylene dicyclohexyl diisocyanate (2,4′-H₁₂MDI) or else mixtures of the aforementioned isomeric methylene dicyclohexyl diisocyanates (H₁₂MDI). Preference is given to using 5-isocyanato-1,3,3-trimethylcyclohexanemethane isocyanate (isophorone diisocyanate), 2,2,4- and 2,4,4-trimethylhexamethylene diisocyanate or methylene dicyclohexyl diisocyanate (H₁₂MDI), or mixtures thereof, and more preferably 4,4′-methylene dicyclohexyl diisocyanate and any desired mixtures of 4,4′-H₁₂MDI, 2,4-H₁₂MDI and 2,2′-H₁₂MDI as component A).

The inventive component A) may also be chain-extended.

Chain extenders and optionally monoamines and/or monoalcohols as chain terminators and have already been described frequently (EP 0 669 353, EP 0 669 354, DE 30 30 572, EP 0 639 598 or EP 0 803 524). Preference is given to polyesters and polyamines as chain extenders and monomeric dialcohols as chain terminators.

Component A) may also comprise additional di- and polyisocyanates. The di- and polyisocyanates used may consist of any desired aromatic, aliphatic and/or cycloaliphatic di- and/or polyisocyanates.

The inventive compositions may be in solid, viscous, liquid and also pulverulent form.

In addition, the compositions may also comprise assistants and additives selected from inhibitors, organic solvents which optionally contain unsaturated moieties, interface-active substances, oxygen and/or free-radical scavengers, catalysts, light stabilizers, color brighteners, photoinitiators, photosensitizers, thixotropic agents, antiskinning agents, defoamers, dyes, pigments, fillers, and matting agents. The amount varies greatly by the field of use and type of assistant and additive.

Useful organic solvents include all liquid substances which do not react with other constituents, for example, acetone, ethyl acetate, butyl acetate, xylene, Solvesso 100, Solvesso 150, methoxypropyl acetate and dibasic esters.

It is possible to add the customary additives, such as leveling agents, for example polysilicones or acrylates, light stabilizers, for example sterically hindered amines, or other assistants as described, for example, in EP 0 669 353, in a total amount of 0.05 to 5% by weight. Fillers and pigments, for example titanium dioxide, can be added in an amount of up to 50% by weight of the overall composition.

The inventive composition is preferably prepared by mixing components A) and B).

The mixing of components A) and B) and optionally further components, for example assistants, etc. can be performed in suitable apparatuses, stirred tanks, static mixers, tubular reactors, kneaders, extruders or other reaction spaces with or without mixing function. The reaction is performed at temperatures between room temperature and 220° C., preferably between room temperature and 120° C., and, according to the temperature and reaction components A) and B), takes between a few seconds and several hours.

The invention also provides for the use of the inventive composition essentially comprising
A) at least one (cyclo)aliphatic diisocyanate prepared by reaction of at least one (cyclo)aliphatic diamine with urea and/or urea equivalents and at least one alcohol to give (cyclo)aliphatic biscarbamates and subsequent thermal cleavage of the (cyclo)aliphatic biscarbamates to give (cyclo)aliphatic diisocyanates,
   and
B) at least one aromatic acid halide,
   as a main component, base component or additional component in coating materials (e.g. textile, paper and leather coating), adhesives, coatings, paints, powder coatings, printing inks and other inks, finishes, glazes, pigment pastes and masterbatches, spackling compounds, sealants and insulating materials, thermoplastic elastomers, especially thermoplastic polyurethanes, thermoset elastomers, foams (e.g. slabstock foams, molded foams), semi-rigid foams (e.g. foam-backed films, energy-absorbing foams, fiber-reinforced foams), integral foams (e.g. rigid and flexible integral foams), heat-insulating materials, RIM materials, materials for medical and hygiene applications (e.g. wound treatment), fibers, gels and microcapsules.

Preferred practical applications are:

RIM materials and UV resins for optical applications, for example lenses and films,
thermoplastic polyurethanes (TPUs) for films, hoses and powders, for example for production of molded skins by the “powder slush” process, NCO-containing prepolymers for moisture-curing coatings and adhesives. The present invention preferably further provides for the use of the inventive compositions in coating compositions, especially as a primer, intermediate layer, topcoat, clearcoat, adhesive or sealing material, and the coating compositions themselves, especially preferably containing compounds of component C), as described in detail below.

The invention also provides for the use of the inventive compositions for production of liquid and pulverulent lacquer coatings on metal, plastic, glass, wood, textile, MDF (medium density fiberboard) or leather substrates.

The invention also provides for the use of the inventive compositions in adhesive compositions for bonds of metal, plastic, glass, wood, textile, paper, MDF (medium density fiberboard) or leather substrates, especially preferably comprising compounds of component C), as described in detail below.

The invention likewise provides metal coating compositions especially for automobile bodies, motorbikes, and pushbikes, building components and domestic appliances, wood coating compositions, glass coating compositions, textile coating compositions, leather coating compositions and plastic coating compositions, which comprise the inventive compositions.

The coating can either be used alone or may be a layer of a multilayer structure. It may be applied, for example, as a primer, as an intermediate layer or as a topcoat or clearcoat. The layers above or below the coating can either be cured thermally in a conventional manner, or else by radiation.

The invention provides polyurethane compositions essentially comprising a composition composed of
A) at least one (cyclo)aliphatic diisocyanate prepared by reaction of at least one (cyclo)aliphatic diamine with urea and/or urea equivalents and at least one alcohol to give (cyclo)aliphatic biscarbamates and subsequent thermal cleavage of the (cyclo)aliphatic biscarbamates to give (cyclo)aliphatic diisocyanates,
   and
B) at least one aromatic acid halide,
   and
C) at least one compound having at least one NCO-reactive group, obtained by reaction of A) with C) in the presence of B).

The polyurethane compositions comprise the reaction product of the diisocyanate A) and the compound C) containing hydroxyl groups, the reaction being effected in the presence of at least one aromatic acid halide B) to reduce the reactivity. Components A) and C) are used in such a mass ratio that the OH:NCO ratio is between 2.0:1.0 and 1.0:2.0, preferably between 1.8:1.0 and 1.0:1.8 and more preferably between 1.6:1.0 and 1.0:1.6.

Thus, polymers and prepolymers are obtained, preferably with an NCO number of 0-30% by weight and an OH number of 500-0 mg KOH/g and an acid number of 0-50 mg KOH/g, and also thermoset or thermoplastic elastomers.

Suitable compounds C) in principle are all of those which have at least one, preferably at least two, functional group(s) reactive toward NCO groups. Suitable functional groups are, for example OH, NH₂—, NH—, SH—, CH-acidic groups. The compounds C) preferably contain 2 to 4 functional groups. Particular preference is given to alcohol groups and/or amino groups.

Suitable diamines and polyamines in principle are: 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, isophoronediamine, 4,7-dioxadecane-1,10-diamine, N-(2-aminoethyl)-1,2-ethanediamine, N-(3-aminopropyl)-1,3-propanediamine, N,N′-1,2-ethanediylbis(1,3-propanediamine), adipic dihydrazide, diethylenetriamine, triethylenetetramine, tetraethylenepentamine, pentaethylenehexamine, dipropylenetriamine, hydrazine, 1,3- and 1,4-phenylenediamine, 4,4′-diphenylmethanediamine, amino-functional polyethylene oxides or polypropylene oxides, adducts formed from salts of 2-acrylamido-2-methylpropane-1-sulfonic acid and hexamethylenediamines which may also bear one or more C₁-C₄ alkyl radicals named. In addition, it is also possible to use di-secondary or primary/secondary diamines, as obtained, for example, in a known manner from the corresponding di-primary diamines by reaction with a carbonyl compound, for example, a ketone or aldehyde, and subsequent hydrogenation, or by addition of di-primary diamines onto acrylic esters or onto maleic acid derivatives.

Mixtures of the polyamines mentioned are also usable. 1,4-Diaminobutane(1,4-butylenediamine) is used only in mixtures.

Examples of amino alcohols include monoethanolamine, 3-amino-1-propanol, isopropanolamine, aminoethoxyethanol, N-(2-aminoethyl)ethanolamine, N-ethylethanolamine, N-butylethanolamine, diethanolamine, 3-(hydroxyethylamino)-1-propanol and diisopropanolamine, including as mixtures.

Suitable compounds C) having SH groups are, for example, trimethylolpropane tri-3-mercaptopropionate, pentaerythrityl tetra-3-mercaptopropionate, trimethylolpropane trimercaptoacetate and pentaerythrityl tetramercaptoacetate.

CH-acidic compounds. Suitable CH acidic compounds are, for example, derivatives of malonic esters, acetylacetone and/or ethyl acetoacetate.

Suitable compounds C) are particularly all diols and polyols which are customarily used in PU chemistry and have at least two OH groups.

The diols and polyols used are, for example, ethylene glycol, 1,2-, 1,3-propanediol, diethylene glycol, dipropylene glycol, triethylene glycol, tetraethylene glycol, 1,2-, 1,4-butanediol, 1,3-butylethylpropanediol, 1,3-methylpropanediol, 1,5-pentanediol, bis(1,4-hydroxymethyl)cyclohexane (cyclohexanedimethanol), glycerol, hexanediol, neopentyl glycol, trimethylolethane, trimethylolpropane, pentaerythritol, bisphenol A, B, C, F, norbornylene glycol, 1,4-benzyldimethanol, -ethanol, 2,4-dimethyl-2-ethylhexane-1,3-diol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl)isocyanurate, mannitol, sorbitol, polypropylene glycols, polybutylene glycols, xylylene glycol or neopentyl glycol hydroxypivalate, hydroxyacrylates, alone or in mixtures.

Particular preference is given to 1,4-butanediol, 1,2-propanediol, cyclohexanedimethanol, hexanediol, neopentyl glycol, decanediol, dodecanediol, trimethylolpropane, ethylene glycol, triethylene glycol, pentane-1,5-diol, hexane-1,6-diol, 3-methylpentane-1,5-diol, neopentyl glycol, 2,2,4(2,4,4)-trimethylhexanediol and neopentyl glycol hydroxypivalate. They are used alone or in mixtures. 1,4-Butanediol is used only in mixtures.

Suitable compounds C) are also diols and polyols which contain further functional groups. These are the linear or lightly branched hydroxyl-containing polyesters, polycarbonates, polycaprolactones, polyethers, polythioethers, polyesteramides, polyacrylates, polyvinyl alcohols, polyurethanes or polyacetals, which are known per se. They preferably have a number-average molecular weight of 134 to 20 000 g/mol, more preferably 134-4000 g/mol. In the case of the hydroxyl-containing polymers, preference is given to using polyesters, polyethers, polyacrylates, polyurethanes, polyvinyl alcohols and/or polycarbonates having an OH number of 5-500 (in mg KOH/gram).

Preference is given to linear or lightly branched hydroxyl-containing polyesters—polyester polyols—or mixtures of such polyesters. They are prepared, for example, by reaction of diols with deficiencies of dicarboxylic acids, corresponding dicarboxylic anhydrides, corresponding dicarboxylic esters of lower alcohols, lactones or hydroxycarboxylic acids.

Diols and polyols suitable for preparation of the preferred polyester polyols are, as well as the abovementioned diols and polyols, also 2-methylpropanediol, 2,2-dimethylpropanediol, diethylene glycol, dodecane-1,12-diol, 1,4-cyclohexanedimethanol and 1,2- and 1,4-cyclohexanediol.

Preference is given to using 1,4-butanediol, 1,2-propanediol, cyclohexanedimethanol, hexanediol, neopentyl glycol, decanediol, dodecanediol, trimethylolpropane, ethylene glycol, triethylene glycol, pentane-1,5-diol, hexane-1,6-diol, 3-methylpentane-1,5-diol, neopentyl glycol, 2,2,4(2,4,4)-trimethylhexanediol and neopentyl glycol hydroxypivalate for preparation of the polyester polyols.

Dicarboxylic acids or derivatives suitable for preparation of the polyester polyols may be aliphatic, cycloaliphatic, aromatic and/or heteroaromatic in nature, and may optionally be substituted, for example by halogen atoms, and/or be unsaturated.

The preferred dicarboxylic acids or derivatives include succinic acid, adipic acid, suberic acid, azelaic acid and sebacic acid, 2,2,4(2,4,4)-trimethyladipic acid, phthalic acid, phthalic anhydride, isophthalic acid, terephthalic acid, dimethyl terephthalate, tetrahydrophthalic acid, maleic acid, maleic anhydride and dimeric fatty acids.

Suitable polyester polyols are also those which can be prepared in a known manner by ring-opening from lactones, such as -caprolactone, and simple diols as starter molecules. It is also possible to use mono- and polyesters formed from lactones, e.g. ε-caprolactone, or hydroxycarboxylic acids, e.g. hydroxypivalic acid, ε-hydroxydecanoic acid, ε-hydroxycaproic acid, thioglycolic acid, as starting materials for the preparation of the polymers G). Polyesters formed from the polycarboxylic acids mentioned above (p. 6) or derivatives thereof and polyphenols, hydroquinone, bisphenol A, 4,4′-dihydroxybiphenyl or bis(4-hydroxyphenyl) sulfone; polyesters of carbonic acid which are obtainable in a known manner from hydroquinone, diphenylolpropane, p-xylylene glycol, ethylene glycol, butanediol or hexane-1,6-diol and other polyols by customary condensation reactions, for example, with phosgene or diethyl or diphenyl carbonate, or from cyclic carbonates, such as glycol carbonate or vinylidene carbonate, by polymerization; polyesters of silicic acid, polyesters of phosphoric acid, for example formed from methane, ethane, β-chloroethane, benzene or styrenephosphoric acid or derivatives thereof, for example phosphoryl chlorides or phosphoric esters, and polyalcohols or polyphenols of the abovementioned type; polyesters of boric acid; polysiloxanes, for example the products obtainable by hydrolysis of dialkyldichlorosilanes with water and subsequent treatment with polyalcohols, those obtainable by addition of polysiloxane dihydrides onto olefins, such as allyl alcohol or acrylic acid, are suitable as starting materials for the preparation of the compounds C).

The polyesters can be obtained in a manner known per se by condensation in an inert gas atmosphere at temperatures of 100 to 260° C., preferably 130 to 220° C., in the melt or in azeotropic mode, as described, for example in Methoden der Organischen Chemie [Methods of Organic Chemistry] (Houben-Weyl); volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961.

Likewise usable with preference are OH-containing (meth)acrylates and poly(meth)acrylates. They are prepared with the copolymerization of (meth)acrylates, where individual components bear OH groups but others do not. For instance, a randomly distributed OH-containing polymer is obtained, which bears no OH groups, one OH group or many OH groups. Such polymers are described in
High solids hydroxy acrylics with tightly controlled molecular weight. van Leeuwen, Ben. SC Johnson Polymer, Neth. PPCJ, Polymers Paint Colour Journal (1997), 187(4392), 11-13;
Special techniques for synthesis of high solid resins and applications in surface coatings. Chakrabarti, Suhas; Ray, Somnath. Berger Paints India Ltd., Howrah, India. Paintindia (2003), 53(1), 33-34,36,38-40; VOC protocols and high solid acrylic coatings. Chattopadhyay, Dipak K.;
Narayan, Ramanuj; Raju, K. V. S, N. Organic Coatings and Polymers Division, Indian Institute of Chemical Technology, Hyderabad, India. Paintindia (2001), 51(10), 31-42.

The diols and dicarboxylic acids or derivatives thereof used to prepare the polyester polyols can be used in any desired mixtures.

It is also possible to use mixtures of polyester polyols and diols.

Suitable compounds C) are also the reaction products of polycarboxylic acids and glycide compounds, as described, for example, in DE-A 24 10 513.

Examples of glycidyl compounds which can be used are esters of 2,3-epoxy-1-propanol with monobasic acids having 4 to 18 carbon atoms, such as glycidyl palmitate, glycidyl laurate and glycidyl stearate, alkylene oxides having 4 to 18 carbon atoms, such as butylene oxide and glycidyl ethers, such as octyl glycidyl ether.

Compounds C) are also those which, as well as an epoxide group, also bear at least one further functional group, for example carboxyl, hydroxyl, mercapto or amino groups, which is capable of reaction with an isocyanate group. Particular preference is given to 2,3-epoxy-1-propanol and epoxidized soybean oil.

It is possible to use any desired combinations of compounds C).

The invention also provides a process for producing polyurethane compositions composed of
A) at least one (cyclo)aliphatic diisocyanate prepared by reaction of at least one (cyclo)aliphatic diamine with urea and/or urea equivalents and at least one alcohol to give (cyclo)aliphatic biscarbamates and subsequent thermal cleavage of the (cyclo)aliphatic biscarbamates to give (cyclo)aliphatic diisocyanates,
   and
B) at least one aromatic acid halide,
   and
C) at least one compound having at least one NCO-reactive group, obtained by reaction of A) and C) in the presence of B).

The invention is illustrated in detail by the examples which follow.

### EXAMPLES

### I) Preparation of the Diisocyanates by the Urea Route

### Example 1

A mixture of 41.0 kg/h of 5-amino-1,3,3-trimethylcyclohexanemethanamine, 29.8 kg/h of unconditioned urea and 107.0 kg/h of n-butanol was pumped via a steam-heated preheater to the first tray of a distillation reactor, as was the reaction mixture with continuous removal of the ammonia released at standard pressure.

The mean residence time in the distillation reactor was 7 h. In the bottom of the distillation reactor operated under standard pressure, 12.5 kg/h of butanol from the bottom of an ammonia-butanol separating column were fed into the bottom of the distillation reactor. The amount of energy supplied to the distillation reactor in the reboiler is regulated such that the amount of butanol which is obtained at the top together with the ammonia formed and is condensed in the dephlegmator with warm water at 40° C. corresponds to that introduced in the bottom. The alcohol thus condensed is conducted continuously into an ammonia-butanol separating column. The solution of bisurea in alcohol obtained in the bottom of the distillation reactor was conducted under level control, via a preheater where it was heated to 190 to 200° C., together with 62.0 kg/h of reaction product from the recarbamatization stage, to the uppermost tray of the pressure distillation reactor. The mean residence time in the pressure distillation reactor was 10.5 h. Heating established the following temperature profile: bottom 229° C. and top 200° C. 103.0 kg/h of butanol were introduced into the bottom of the pressure distillation reactor, and the amount of heat carrier oil to the reboiler was regulated such that the amount of butanol drawn off at the top together with the ammonia formed corresponded to that fed in in the bottom.

The resulting butanol/ammonia mixture was subsequently conducted into the ammonia-butanol separating column. The top temperature there was 85° C. The butanol losses which arose through the ammonia discharge and from other losses (low boiler components and residues sent to incineration) were replaced by supplying 4.7 kg/h of fresh butanol into the bottom of the ammonia-butanol separating column. The mixture of 233.2 kg/h obtained in the bottom of the pressure distillation reactor was purified by distillation.

115.5 kg/h of biscarbamate were fed into the falling film evaporator of the combined cleavage and rectification column after addition of 0.2 kg/h of catalyst solution. The energy required for the cleavage and rectification was transferred with heat carrier oil in the falling film evaporator. The carbamate cleavage reaction was undertaken at a bottom pressure of 27 mbar and a bottom temperature of 230° C. The butanol of 40.0 kg/h which was formed during the cleavage and obtained at the top by rectification was drawn off and fed to the recarbamatization stage with the bottoms discharge of 21.7 kg/h from the combined cleavage and rectification column.

The crude diisocyanate of 55.4 kg/h drawn off in a side stream from the combined cleavage and rectification column was fed to a further purifying distillation, and 52.0 kg/h of purified diisocyanate were thus obtained. The purity of the diisocyanate obtained was determined by gas chromatography to be >99.5% by weight. The overall process yield based on diamine used was 97.2%.

### Example 2

A mixture of 38.4 kg/h of 5-amino-1,3,3-trimethylcyclohexanemethanamine, 27.9 kg/h of unconditioned urea, 100.1 kg/h of n-butanol and 57.4 kg/h of reaction product from the recarbamatization stage was pumped via a steam-heated preheater, where it was heated to 190 to 200° C., to the first tray of a pressure distillation reactor.

The mean residence time in the pressure distillation reactor was 10.5 h. Heating established the following temperature profile: bottom 230° C. and top 200° C. 96.7 kg/h of butanol were introduced into the bottom of the pressure distillation reactor, and the amount of heat carrier oil to the reboiler was regulated such that the amount of butanol drawn off at the top together with the ammonia formed corresponded to that fed in in the bottom.

The resulting butanol/ammonia mixture was subsequently conducted into the ammonia-butanol separating column. The top temperature there was 87° C. The butanol losses which arose through the ammonia discharge and from other losses (low boiler components and residues sent to incineration) were replaced by supplying 4.7 kg/h of fresh butanol in the bottom of the ammonia-butanol separating column. The mixture of 220.2 kg/h obtained in the bottom of the pressure distillation reactor was purified by distillation. 105.5 kg/h of biscarbamate were fed into the falling film evaporator of the combined cleavage and rectification column after addition of 0.2 kg/h of catalyst solution. The energy required for the cleavage and rectification was transferred with heat carrier oil in the falling film evaporator. The carbamate cleavage reaction was undertaken at a bottom pressure of 27 mbar and a bottom temperature of 230° C. The butanol of 37.1 kg/h which was formed during the cleavage and obtained at the top by rectification was drawn off and fed to the recarbamatization stage with the bottoms discharge of 20.1 kg/h from the combined cleavage and rectification column.

The crude diisocyanate of 51.4 kg/h drawn off in a side stream from the combined cleavage and rectification column was fed to a further purifying distillation, and 48.2 kg/h of purified diisocyanate were thus obtained. The purity of the diisocyanate obtained was determined by gas chromatography to be >99.5% by weight. The overall process yield based on diamine used was 96.3%.

### Example 3

A mixture of 34.7 kg/h of (2,2,4-)2,4,4-trimethylhexamethylenediamine, 27.2 kg/h of unconditioned urea, 97.8 kg/h of n-butanol and 64.0 kg/h of reaction product from the recarbamatization stage was pumped via a steam-heated preheater, where it was heated to 190 to 200° C., to the first tray of a pressure distillation reactor.

The mean residence time in the pressure distillation reactor was 10.5 h. Heating established the following temperature profile: bottom 228° C. and top 200° C. 94.3 kg/h of butanol were introduced into the bottom of the pressure distillation reactor, and the amount of heat carrier oil to the reboiler was regulated such that the amount of butanol drawn off at the top together with the ammonia formed corresponded to that fed in in the bottom.

The resulting butanol/ammonia mixture was subsequently conducted into the ammonia-butanol separating column. The top temperature there was 86° C. The butanol losses which arose through the ammonia discharge and from other losses (low boiler components and residues sent to incineration) were replaced by supplying 4.5 kg/h of fresh butanol in the bottom of the ammonia-butanol separating column. The mixture of 219.0 kg/h obtained in the bottom of the pressure distillation reactor was purified by distillation.

108.4 kg/h of biscarbamate were fed into the falling film evaporator of the combined cleavage and rectification column after addition of 0.2 kg/h of catalyst solution. The energy required for the cleavage and rectification was transferred with heat carrier oil in the falling film evaporator. The carbamate cleavage reaction was undertaken at a bottom pressure of 27 mbar and a bottom temperature of 228° C. The butanol of 38.1 kg/h which was formed during the cleavage and obtained at the top by rectification was drawn off and fed to the recarbamatization stage with the bottoms discharge of 25.7 kg/h from the combined cleavage and rectification column.

The crude diisocyanate of 47.5 kg/h drawn off in a side stream from the combined cleavage and rectification column was fed to a further purifying distillation, and 44.6 kg/h of purified diisocyanate were thus obtained. The purity of the diisocyanate obtained was determined by gas chromatography to be >99.5% by weight. The overall process yield based on diamine used was 96.6%.

### Example 4

The uppermost tray of a pressure distillation reactor was charged with 31.9 kg/h of H₁₂MDA, 18.7 kg/h of unconditioned urea and 67.4 kg/h of n-butanol, and the reaction mixture was converted with continuous removal of the ammonia released at 10 bar, 220° C. and with a mean residence time of 10.5 h. In the bottom of the pressure distillation reactor, 66.1 kg/h of butanol were fed in, and the amount of alcohol drawn off at the top together with the ammonia released was selected such that it corresponded to the alcohol input in the bottom. The resulting butanol/ammonia mixture was subsequently conducted into the ammonia-butanol separating column. The top temperature there was 86° C. The butanol losses which arose through the ammonia discharge and from other losses (low boiler components and residues sent to incineration) were replaced by supplying fresh butanol in the bottom of the ammonia-butanol separating column. The reactor discharge, together with the material of value stream from the high boiler removal, was freed by distillation of excess butanol and low and medium boilers, and the remaining 89.9 kg/h of bis(4-butoxycarbonylaminocyclo-hexyl)methane (H₁₂MDU) were conducted as a melt (140° C.) into the circulation system of the falling film evaporator of the cleavage and rectification column, and the deblocking reaction was performed at a temperature of 234° C. and a bottom pressure of 8 mbar in the presence of a catalyst. The crude H₁₂MDI obtained was fed to a purifying distillation to obtain 37.3 kg/h of pure H₁₂MDI. 26.3 kg/h of crude butanol were obtained as the top product of the cleavage and rectification column. To maintain constant mass within the cleavage and rectification column, and prevent deposits and blockages of the cleavage apparatus, a substream was discharged continuously from the circulation system and combined with 2.2 kg/h of bottoms discharge from the H₁₂MDI purifying distillation and the top product from the cleavage and rectification column and reurethanized. The reurethanized stream was freed of excess butanol and separated by distillation into a waste stream rich in high boilers and a material of value stream. The 28.8 kg/h of material of value stream was fed together with the reactor discharge of the diurethane preparation to the flash stage. The purity of the diisocyanate obtained was determined by gas chromatography to be >99.5% by weight. The overall process yield based on diamine used was 93.8%.

Table 1 below shows once again, in summary, the essential features of examples 1 to 4 with the significant differences in the diisocyanate purities and the process yields depending on the urea quality used.

TABLE 1

| | | Example | | | |
|---|---|---|---|---|---|
| Name | Dimension | 1 | 2 | 3 | 4 |
| Diamine | kg/h | IPD | IPD | TMD | H₁₂MDA |
| | | 41 | 38.4 | 34.7 | 31.9 |
| Urea with | kg/h | 29.8 | 27.9 | 27.2 | 18.7 |
| <10 ppm of | | | | | |
| formaldehyde | | | | | |
| Urea with 0.55% | kg/h | 0 | 0 | 0 | 0 |
| by wt. of | | | | | |
| formaldehyde | | | | | |
| Diisocyanate | kg/h | 52.0 | 48.2 | 44.6 | 37.3 |
| Diisocyanate | % by wt. | >99.5 | >99.5 | >99.5 | >99.5 |
| purity | | | | | |
| Process yield | % | 97.2 | 96.3 | 96.6 | 93.8 |

IPD: 5-amino-1,3,3-trimethylcyclohexanemethanamine
TMD: (2,2,4-)2,4,4-trimethylhexamethylenediamine
H₁₂MDA: mixture of isomeric methylenedicyclohexyldiamine

The diisocyanate purities were determined by gas chromatography:

### Instrument: HP3/Agilent GC 6890

Separating column: HP5/Agilent 30 m×320 μm×0.25 μm nominal

The process yield is calculated from diisocyanate obtained based on diamine used.

Reaction with n-octanol

### Comparative Example A

A mixture of 52.52 g of an H₁₂MDI prepared by the phosgene process and 83.38 g of 2-methoxypropyl acetate is initially charged in a three-neck flask under nitrogen and heated to 80° C. while stirring. At this temperature, 51.10 g of n-octanol which have likewise been heated beforehand to 80° C. are added via a dropping funnel within 10 seconds. The reaction mixture subsequently kept at a temperature of 80° C. while stirring. The percentage conversion of the urethane reaction is determined via the NCO number. The conversion in this case was 30% after 3 hours and 43% after 7 hours.

### Comparative Example B

A mixture of 52.52 g of an H₁₂MDI prepared by the urea route (VESTANAT H₁₂MDI) and 83.38 g of 2-methoxypropyl acetate is initially charged in a three-neck flask under nitrogen and heated to 80° C. while stirring. At this temperature, 51.10 g of n-octanol which have likewise been heated beforehand to 80° C. are added via a dropping funnel within 10 seconds. The reaction mixture subsequently kept at a temperature of 80° C. while stirring. The percentage conversion of the urethane reaction is determined via the NCO number. The conversion in this case was 51% after 3 hours and 78% after 7 hours.

### Inventive Example I

A mixture of 52.52 g of an H₁₂MDI prepared by the urea route, 83.38 g of 2-methoxypropyl acetate and 0.0188 g of benzoyl chloride is initially charged in a three-neck flask under nitrogen and heated to 80° C. while stirring. At this temperature, 51.10 g of n-octanol which have likewise been heated beforehand to 80° C. are added via a dropping funnel within 10 seconds. The reaction mixture subsequently kept at a temperature of 80° C. while stirring. The percentage conversion of the urethane reaction is determined via the NCO number. The conversion in this case was 29% after 3 hours and 46% after 7 hours. Thus, the reactivity of the H₁₂MDI prepared by the urea route, after addition of benzoyl chloride, corresponds to that of the H₁₂MDI prepared by the phosgene process (comparative example A).

### Synthesis of a Prepolymer

### Comparative Example C

189.72 g of a polyester diol having an OH number of 113 mg KOH/g and a glass transition temperature of approx. −60° C. and 110.28 g of an H₁₂MDI prepared by the phosgene process are initially charged under nitrogen in a three-neck flask equipped with precision glass stirrer, thermometer and reflux condenser. The mixture is heated to 90° C. while stirring and kept at this temperature until an NCO number of 6.4% has been attained. In the case of the H₁₂MDI prepared by the phosgene process, this is the case after 4.5 hours.

### Comparative Example D

189.72 g of a polyester diol having an OH number of 113 mg KOH/g and a glass transition temperature of approx. −60° C. and 110.28 g of an H₁₂MDI prepared by the urea route are initially charged under nitrogen in a three-neck flask equipped with precision glass stirrer, thermometer and reflux condenser. The mixture is heated to 90° C. while stirring and kept at this temperature until an NCO number of 6.4% has been attained. In the case of the H₁₂MDI prepared by the urea route, this is the case after 2 hours.

### Inventive Example II

189.72 g of a polyester diol having an OH number of 113 mg KOH/g and a glass transition temperature of approx. −60° C., 110.28 g of an H₁₂MDI prepared by the urea route and 5.5 mg of benzoyl chloride are initially charged under nitrogen in a three-neck flask equipped with precision glass stirrer, thermometer and reflux condenser. The mixture is heated to 90° C. while stirring and kept at this temperature until an NCO number of 6.4% has been attained. In this example, this is the case after 4.5 hours. Thus, the reactivity of the H₁₂MDI prepared by the urea route, after the addition of benzoyl chloride, corresponds to that of the H₁₂MDI prepared by the phosgene process (comparative example C).

1. A composition, comprising:
A) a (cyclo)aliphatic diisocyanate obtained by a process comprising reacting a (cyclo)aliphatic diamine with (i) at least one selected from the group consisting of a urea and a urea equivalent and (ii) alcohol, to obtain a (cyclo)aliphatic biscarbamate, and then thermally cleaving the (cyclo)aliphatic biscarbamate, to obtain the (cyclo)aliphatic, diisocyanate; and
B) an aromatic acid halide.

2. The composition of claim 1, wherein component A) comprises at least one selected from the group consisting of hexamethylene diisocyanate, 2-methylpentane diisocyanate, 2,2,4-trimethylhexamethylene diisocyanate, 2,4,4-trimethylhexamethylene diisocyanate, octamethylene diisocyanate, decamethylene diisocyanate, 2-methylnonamethylene diisocyanate, dodecamethylene diisocyanate, 1,4-diisocyanatocyclohexane, 1,3-cyclohexane-dimethane isocyanate, 1,4-cyclohexane-dimethane isocyanate, 5-isocyanato-1,3,3-trimethylcyclohexanemethane isocyanate (isophorone diisocyanate), 4,4′-methylene dicyclohexyl diisocyanate (4,4′-H₁₂MDI), 2,2′-methylene dicyclohexyl diisocyanate (2,2′-H₁₂MDI), and 2,4′-methylene dicyclohexyl diisocyanate (2,4′-H₁₂MDI).

3. The composition of claim 1, wherein component A) comprises isophorone diisocyanate.

4. The composition of claim 1, wherein component A) comprises 4,4′-H₁₂MDI or at least two selected from the group consisting of 4,4′-H₁₂MDI, 2,4-H₁₂MDI, and 2,2′-H₁₂MDI.

5. The composition of claim 1, wherein component A) comprises at least one selected from the group consisting of 2,2,4-trimethylhexamethylene diisocyanate and 2,4,4-trimethylhexamethylene diisocyanate.

6. The composition of claim 1, wherein the aromatic acid halide B) is at least one selected from the group consisting of a chloride, a fluoride, a bromide and an iodide.

7. The composition of claim 1, wherein a content of component B) in the composition is from 0.0001 to 1.0% by weight, based on a total weight of the (cyclo)aliphatic diisocyanate.

8. The composition of claim 1 further comprising:
at least one selected from the group consisting of an inhibitor, an organic solvent optionally comprising an unsaturated moiety, an interface-active substance, an oxygen and/or a free-radical scavenger, a catalyst, a light stabilizer, a color brightener, a photoinitiator, a photosensitizer, a thixotropic agent, an antiskinning agent, a defoamer, a dye, a pigment, a filler, a matting agent, a leveling agent, a light stablilizer.

9. A process for producing the composition of claim 1, the process comprising:
mixing component A) and B), and optionally a further component, in an apparatus selected from the group consisting of a stirred tank, a static mixer, a tubular reactor, a kneader, an extruder, and another reaction space with or without mixing function, at a temperature in a range from room temperature to 220° C.

10. A method of manufacturing a coating material, adhesive, coating, paint, powder coating, ink, finish, glaze, pigment paste, masterbatch, spackling compound, sealant, insulating material, thermoplastic elastomer, thermoset elastomer, foam, semi-rigid foam, integral foam, heat-insulating material, RIM material, medical material, hygiene application, fiber, fiber composite, gel, or microcapsule, the method comprising:
combining the (cyclo)aliphatic diisocyanate A) and the aromatic acid halide B) of the composition of claim 1, with the coating material, adhesive, coating, paint, powder coating, ink, finish, glaze, pigment paste, masterbatch, spackling compound, sealant, insulating material, thermoplastic elastomer, thermoset elastomer, foam, semi-rigid foam, integral foam, heat-insulating material, RIM material, medical material, hygiene application, fiber, fiber composite, gel, or microcapsule.

11. The method of claim 10, wherein the composition is combined with a coating material.

12. The method of claim 10, wherein the composition is combined with an adhesive.

13. A coating composition, comprising the composition of claim 1, wherein the coating composition is a metal coating composition, a wood coating composition, a leather coating composition, a textile coating composition, a plastic coating composition, or a glass coating composition.

14. A polyurethane composition, comprising:
the (cyclo)aliphatic diisocyanate A) and the aromatic acid halide B) of the composition of claim 1; and
C) a compound comprising an NCO-reactive group,
wherein the polyurethane composition is obtained by reacting A) with C) in the presence of B).

15. A process for producing the polyurethane composition of claim 14, the process comprising:
reacting the (cyclo)aliphatic diisocyanate A) with the compound C) in the presence of the aromatic acid halide B).

16. The composition of claim 6, wherein the aromatic acid halide B) comprises an aromatic acid chloride.

17. The composition of claim 6, wherein the aromatic acid halide B) comprises benzyl chloride.

18. The composition of claim 7, wherein a content of component B) in the composition is from 0.001 to 0.9% by weight, based on a total weight of the (cyclo)aliphatic diisocyanate.

19. The composition of claim 7, wherein a content of component B) in the composition is from 0.002 to 0.5% by weight, based on a total weight of the (cyclo)aliphatic diisocyanate.

20. The composition of claim 19, wherein component A) comprises isophorone diisocyanate.
